(19) United States
(12) Patent Application Publication
(10) Pub. No.: US 2026/0077417 A1
(43) Pub. Date: Mar. 19, 2026

(54) Process for the Additive Manufacturing of Three-Dimensional Objects Using Wire Arc Cladding

(71) Applicant: Bayerische Motoren Werke Aktiengesellschaft, Muenchen (DE)

(72) Inventors: Moritz BALDAUF, Muenchen (DE); Tobias HAUSER, Bubesheim (DE)

(21) Appl. No.: 19/105,853

(22) PCT Filed: Aug. 9, 2023
(86) PCT No.: PCT/EP2023/071998

§ 371 Date: Feb. 24, 2025

(30) Foreign Application Priority Data
Aug. 25, 2022 (DE) 10 2022 121 529.6

(51) Int. Cl. B23K 9/04; B23K 9/095; B23K 9/173; B23K 31/12; B33Y 10/00; B33Y 30/00; B33Y 50/00

(52) U.S. Cl. CPC B23K 9/04; B23K 9/0956; B23K 9/173; B23K 31/125; B33Y 10/00; B33Y 30/00; B33Y 50/00

(57) ABSTRACT

A process for additively manufacturing three-dimensional objects using arc-wire deposition welding, in particular by layer-by-layer melting and solidifying of a building material that is in the form of a wire in its original state. During the manufacturing process, at least two different surfaces of at least one partially manufactured three-dimensional object are captured by at least two different capturing devices, and at least one building quality parameter describing a building quality of the object is determined.

### BACKGROUND AND SUMMARY

This disclosure relates to a method for additive manufacture of three-dimensional objects by way of arc-wire deposition welding, in particular layer-by-layer melting and solidification of a building material which is wire-shaped in its initial state.

Methods for additive manufacture of three-dimensional objects in which arc-wire deposition welding is used to build up the object layer-by-layer are known in principle from the prior art. In such methods, a metallic wire is melted on by way of an electric arc in such a way that, in the cooled state of the wire, the desired cross section of the three-dimensional object to be produced is formed in each layer.

As in all additive manufacturing methods, process errors or anomalies that adversely affect the component quality, for example the mechanical properties of the object, can occur. For example, cracks or gaps can occur in the component or oxidation of the building material can occur. To prevent this, the process can be monitored, for example in that a worker visually monitors the additive manufacture of the object. In order to allow visual inspection by the worker, the production process normally has to be interrupted so that the worker can view all the relevant surfaces. Furthermore, it should be taken into account that the visual inspection by the worker amounts to a subjective assessment or evaluation of the component quality.

The visual inspection by a worker and the interruption to the process not only give rise to personnel costs but also reduce the automation of the process due to the interruption and the subjective assessment of the worker. In particular, process errors can be recognized only when they are already present to a pronounced extent in the object, so that the worker can recognize these visually.

The disclosure is based on an objective of specifying an improved method for additive manufacture of three-dimensional objects by way of arc-wire deposition welding, in which in particular the monitoring of the production process is improved.

As described, the disclosure relates to a method for additive manufacture of three-dimensional objects by way of arc-wire deposition welding, in particular layer-by-layer melting and solidification of a building material which is wire-shaped in its initial state. In other words, a wire can be delivered at a defined advancing rate, and melted on by way of an electric arc, in order to form layers of the three-dimensional object after the melted building material has cooled down.

The disclosure is based on the realization that, during the production process, at least two different surfaces of at least one partially produced three-dimensional object are captured by way of at least two different capturing devices and at least one building-quality parameter, which describes a building quality of the object, is determined. Advantageously, the method according to the disclosure makes it possible for different surfaces, for example all the surfaces, of the three-dimensional object partially produced in the additive manufacturing process to be able to be monitored. For example, images can be recorded from different directions by way of the different capturing devices so that the individual surfaces or sides of the three-dimensional object being produced can be captured. This makes possible for example automated capturing of whether the additive manufacturing process is being carried out correctly or whether there are arising during the production process errors or anomalies which, if appropriate, can be corrected or compensated for as early as possible.

Thus, in comparison with the above-described prior art, no visual monitoring by a worker is necessary, but rather the at least two different capturing devices are able to monitor adherence to the quality requirements for the component in an automated manner and, if appropriate, make possible early recognition of process errors or anomalies. For this purpose, by way of the capturing devices, the surfaces of the object that are assigned thereto are captured and, on the basis of the capturing result, a building-quality parameter, which describes a building quality of the object, is determined. The building quality may be defined for example by whether the object is built without defects or whether defects for which a measure is required are present in the object, in particular in the present or most recently produced layer. If, for example, the building-quality parameter reveals that the building quality of the object is sufficiently met, the additive manufacturing process can be continued. If, by contrast, the building-quality parameter indicates the presence of at least one effect relating to the building quality of the object, for example an oxidation, a crack or a gap, then, as will be described below, measures may be implemented to ensure adherence to or attainment of a defined building quality of the object.

The building-quality parameter may be determined for at least two surfaces, in particular all the surfaces, of the object by way of capturing devices which are oriented differently, in particular are oriented at least 90° with respect to one another. As described, provision may be made of at least two capturing devices that, from different directions, capture the object being produced. Orientation of the capturing devices may be understood as meaning for example the orientation of a central axis of the capturing region. Provision may be made of multiple capturing devices whose orientations or capturing directions are oriented at 90° with respect to one another. In particular, each side or surface of the object may be assigned its own capturing device. For example, in the case of a substantially rectangular or cuboidal buildup space or buildup volume, a capturing device may be provided at each surface. The capturing devices may be oriented along the surface normals to the lateral surfaces of the buildup volume. For example, the method may be carried out by way of four capturing devices assigned to the lateral surfaces and one capturing device assigned to the top surface. If a defect or a process error is recognized at one of the surfaces, a corresponding measure may be implemented to correct or compensate for the process error or to reduce the occurrence of process errors.

According to a further configuration of the method, at least one defect may be captured in at least one surface of the object, and the building-quality parameter may be determined on the basis of the captured defect. As already described, the building-quality parameter may in principle describe the building quality of the object. In particular, the building-quality parameter may indicate whether a defect has occurred or occurs in the additive manufacturing process. The building-quality parameter may for example indicate where, or in which lateral surface of the object, the defect occurs. It is also possible for the building-quality parameter to indicate the quality or type of defect, for example whether the defect is able to be corrected, requires a measure or leads to termination of the building process.

The building-quality parameter may be determined in principle on the basis of raw data that has been captured via the plurality of capturing devices. According to one configuration of the disclosure, the building-quality parameter may be determined on the basis of at least one defect captured by way of a capturing algorithm, in particular artificial intelligence (“AI”) and/or computer vision and/or pattern recognition. The capturing algorithm described may be applied for example to image data which has been captured by way of the multiple capturing devices. The capturing algorithm may in principle be used to determine whether, in the recorded or captured image data, a defect is present in the respective surface of the object.

For example, the raw data or the image data captured by way of the capturing devices may be used as input data for the capturing algorithm. The capturing algorithm subsequently captures whether a defect is present in the recorded image data. If no defect is present, a building-quality parameter which indicates a sufficient building quality for the object being produced may be output as output. If a defect is recognized, a corresponding building-quality parameter may be output. Subsequently, as will be described below, a measure may be initiated to handle the building quality reduced by the defect.

In the simplest case, in addition to the raw data recorded by the capturing devices, the capturing algorithm may also be provided with a target state for the respective surface or surface structure on the surface, so that the algorithm can ascertain a deviation from the target state, for example whether a defect is present. This may be realized for example on the basis of artificial intelligence, computer vision or pattern recognition. For example, the capturing algorithm may be provided with corresponding patterns associable with a defect that capture this in relation to the target state, and thus output the correct building-quality parameter.

In other words, the at least one defect may be captured on the basis of a deviation of a captured surface from a target state. For this purpose, it is possible in particular for the capturing algorithm to be provided with the target state of the surface, for example the shape that the surface is intended to assume in its ideal state. The capturing algorithm may then be based on a comparison of the target state with the raw data recorded by the capturing devices or by the capturing device which is responsible for the captured surface.

The execution of the capturing algorithm may be preceded by a machine learning process, or training of pattern errors may be carried out in advance for the capturing algorithm. For example, common or expected defects may be labelled, that is to say the capturing algorithm may be provided with such defects in classified form, so that the capturing algorithm can then independently capture and recognize such defects. In this case, in addition to the training of the capturing algorithm, it is possible for provision to be made of a continuous, ongoing learning process, for example outputting of corresponding feedback in the case of a deviation from a target state not being captured clearly. Through corresponding inputting as to whether such unclear capturing involves a defect or not, the capturing algorithm can be continuously improved further.

The capturing algorithm described may be applied in principle to all the raw data that, as already described above, can be captured for each surface of the object or each side of the buildup volume in a mutually independent manner. This makes it possible in particular for the building-quality parameter to be captured and output in an automated manner without the production process being interrupted.

As described above, to continue the further production process, different measures may be implemented according to the building-quality parameter determined. One possibility is that at least one process parameter is adapted according to the building-quality parameter. In principle, process parameter may be understood as meaning any variable parameter in the additive manufacturing process and any such parameter may be adapted as a process parameter. For example, a gas flow rate, meaning in particular a flow speed or a volumetric flow rate of a process gas used in the manufacturing process, may be influenced. A further possibility is to adapt so-called path planning in the additive manufacturing process. Path planning is to be understood as meaning for example determination of the locations at which and the sequence in which material is selectively deposited on a particular layer in the additive manufacturing process or the configuration or selection of the movement speeds of a processing head. A further possibility is to adapt a wire advancing rate and/or an advancing rate of a processing head. In this way, in particular how fast building material is deposited at which locations may be set.

Furthermore, waiting times and/or cooling times and process temperatures may be changed, for example in order for various process errors to be reduced or prevented in the future. A further possibility may make provision for adaptation of a component property, for example for changing of a geometry parameter of the component or of at least one process parameter according to a component property. If, for example, via capturing by one of the capturing devices, it can be captured that weld seams are formed comparatively low in relation to how they are defined in a target state, it can be ascertained therefrom that the process temperature was too high. In this case, for improving the building quality, heat may be released to an increased extent or a relatively long waiting time between two layers may be planned in order to thus increase the emitted heat and reduce the temperature.

According to a further configuration of the method, it may be provided that termination of the building process or correction of a determined defect is carried out according to the building-quality parameter. If the building-quality parameter indicates for example that a process error or a defect is so serious as not to be able to be corrected during the further course of the production process, automated termination of the production process may be realized. If the building-quality parameter reveals that correction of a determined defect can be carried out, then this may subsequently be carried out. In principle, it is then possible for a captured defect to be compensated or improved.

For correcting a determined defect, compensation of the defect may be carried out in at least one subsequent layer, in particular with a change to at least one process parameter, and/or at least one layer having the defect may be removed and a new layer, in particular with a change to at least one process parameter, may be deposited. Depending on the determine building-quality parameter, it is thus possible, for example in the case of a minor process error, for the process parameter to be adapted so that the process error that occurred can be compensated or no longer occurs in a subsequent layer.

If, by contrast, a serious process error has occurred, this may be corrected by removing the layer having the defect and depositing a new layer. For this purpose, the layer having the defect is removed, for example by way of milling. Subsequently, to prevent the defect from occurring again in a newly deposited layer, at least one process parameter may be changed. Afterwards, the new layer may be deposited using the new set of process parameters, so that renewed occurrence of the defect is prevented. The apparatus at which the method is carried out may have for example a device for tool-changing by way of which a changeover to a removal device, for example a milling head, is possible. Alternatively, a corresponding tool may be additionally provided.

As described above, it is in principle possible for use to be made of any suitable capturing devices for capturing the surfaces of the object. According to a specific configuration, the at least two different surfaces of the object may be captured by way of a CCD (charge-coupled device) and/or a CMOS (complementary metal-oxide-semiconductor) and/or a thermal image, in particular based on color and/or temperature and/or on depth information. In this case, a basic combination of different capturing devices is also possible. In particular, at least two different capturing devices that are based on different capturing mechanisms may be assigned to the same surface. It is in principle also possible for different capturing devices with different mechanisms to be assigned to different surfaces.

Beside the method, the disclosure relates to an apparatus for additive manufacture of three-dimensional objects by way of arc-wire deposition welding, in particular layer-by-layer melting and solidification of a building material which is wire-shaped in its initial state, which apparatus comprises a capturing apparatus with at least two differently oriented capturing devices which are configured to capture at least two different surfaces of at least one partially produced three-dimensional object during the production process, wherein the capturing apparatus is configured to determine at least one building-quality parameter, which describes a building quality of the object.

The capturing apparatus thus comprises a plurality of capturing devices, or at least two capturing devices, that may be assigned to different surfaces of the object, that is to say different sides of the buildup volume. In this way, it is possible for process errors that occur to be captured in different surfaces of the object simultaneously and for a building-quality parameter to be determined. For the determination of the building-quality parameter, the apparatus may have for example a separate control device or the capturing apparatus may have a control device, for example a processor, on which the above-described capturing algorithm is able to be executed.

All of the advantages, details, embodiments and/or features that have been described with respect to the method are completely transferable to the apparatus, and vice versa.

### BRIEF DESCRIPTION OF THE DRAWINGS

The disclosure is discussed on the basis of exemplary embodiments with reference to the figures. The figures are schematic illustrations.

FIG. 1 shows a basic illustration of an apparatus for additive manufacture of a three-dimensional object by way of arc-wire deposition welding according to a first exemplary embodiment;

FIGS. 2a-2c show a schematic sequence diagram of a method according to a second exemplary embodiment; and

FIGS. 3a-3c show a schematic sequence diagram of a method according to a third exemplary embodiment.

### DETAILED DESCRIPTION OF THE DRAWINGS

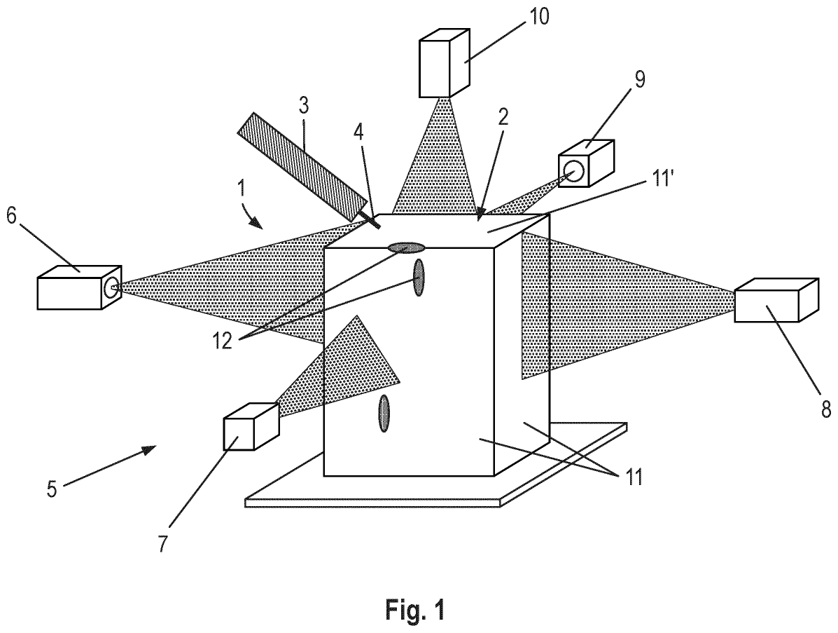

FIG. 1 schematically shows an apparatus 1 for additive manufacture of three-dimensional objects 2, wherein the three-dimensional object 2 is produced layer-by-layer by way of arc-wire deposition welding. The apparatus 1 has a processing head 3, for example a deposition device, which is configured to melt on a building material 4, wire-shaped in its initial state, while generating an electric arc. In other words, the apparatus 1 is configured to position the processing head 3 into different positions over the object 2 or relative to the object 2, and to deposit building material 4 layer-by-layer, in order to additively manufacture the object 2.

The apparatus 1 has a capturing apparatus 5 with multiple capturing devices 6-10 which are configured to capture different surfaces 11 of the partially finished object 2 during the production process. The capturing devices 6-10 may comprise a camera, an optical sensor, etc. The arrangement of the capturing devices 6-10 is merely exemplary and schematic and may be adapted in any desired manner in relation to the object 2 specifically to be produced or the specific apparatus 1. In this example, the capturing devices 6-10 are assigned to or oriented towards different surfaces 11, 11′ of the partially finished object 2. In the specifically illustrated exemplary embodiment, in each case one surface 11, 11′ of the object 2 is assigned to a capturing device 6-10 and the latter is configured to capture the surface 11, 11′. In the exemplary embodiment shown, four capturing devices 6-9 for the lateral surfaces 11 and one capturing device 10 for the top surface 11′ are illustrated. For example, the capturing devices 6-10 are oriented along the surface normals to the lateral surfaces 11 of the object 2 or the buildup volume, which is of cuboidal form in this case.

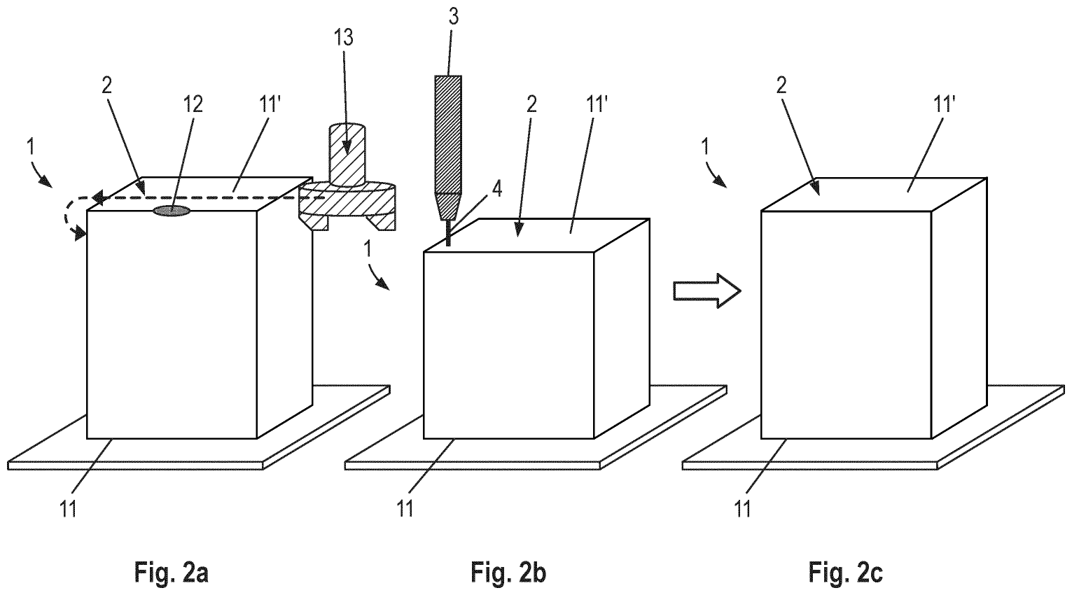

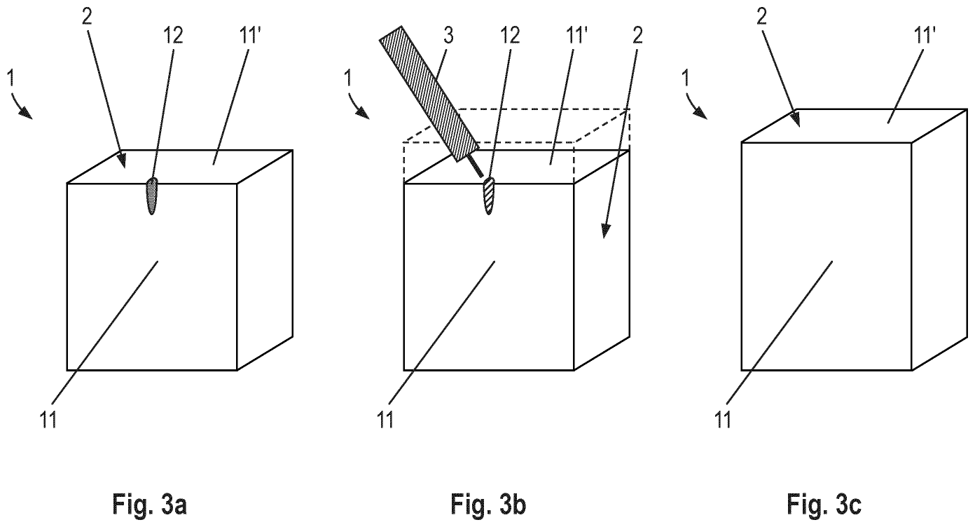

Illustrated merely by way of example are multiple defects 12 which are able to be captured by one of the capturing devices 6-10. The illustration should be understood merely as an example because, as will be described below in relation to FIGS. 2 and 3, if defects 12 are captured, measures are implemented such that said defects are corrected or compensated. For this purpose, the capturing devices 6-10 are able to capture images of the surfaces 11, 11′ of the object 2 that are assigned to said capturing devices and to provide said images for example as raw data. The capturing apparatus 5 may have a control device (not illustrated in any more detail), for example in the form of a processor, on which a capturing algorithm is able to be executed. The capturing apparatus 5 may have a storage, for example in the form of a memory, in which the capturing algorithm is stored. The capturing algorithm may be provided with for example the captured raw data. The capturing algorithm can then capture the defects 12. In particular, a building-quality parameter, which indicates the building quality of the object 2, can be determined.

In this case, the capturing device 8 may output a building-quality parameter which indicates that the surface 11, 11′ assigned thereto has been produced without defects, so that the building quality of the object 2 in relation to the surface assigned to the capturing device 8 meets set quality requirements. The capturing devices 7, 10 capture defects 12 in this example, however, so that accordingly a building-quality parameter which indicates that the quality requirements for the object 2 are not met may be output. The defects 12 can be captured for example via a comparison with a target state of the respective surfaces 11, 11′, it being possible for example for the capturing apparatus 5 to be provided with a target state for the respective surfaces 11, 11′ of the object 2. Deviations from the target state may then be ascertained or determined to be a defect 12.

The above-described capturing algorithm may be based for example on pattern recognition, AI or computer vision. In particular, various common forms of defects 12, for example color-based or depth-data-based or shape-based defects, can be machine learned in a training process. As described, as long as the determined building-quality parameter does not output a defect 12 or as long as the building-quality parameter confirms adherence to a required quality on the part of the partially produced object 2, the production process can be continued. If a defect 12 is captured, measures described below on the basis of FIGS. 2-3 may be implemented by the apparatus 1.

FIG. 2a shows by way of example an object 2 for which a defect 12 in the presently produced layer has been captured by way of one of the capturing devices 6-10, for example the capturing devices 7, 10. The defect 12 may constitute for example an oxidation, a gap or a crack in the object 2. Output on the basis of the captured defect 12, which was determined for example by pattern recognition in the raw data of the images recorded by the capturing devices 7, 10, is a building-quality parameter that prevents further continuation of the additive manufacturing process and initiates correction of the defect 12.

As illustrated in FIG. 2a, the previously produced layer having the defect 12 is removed, in particular by way of a milling device 13. The apparatus 1 may in this case control the milling device 13 in such a way that the layer bearing the previously captured defect 12 is removed and the additive production process can then be continued. The use of the milling device 13 should in this case be understood as being exemplary. It is also possible for the layer having the defect 12 to be removed in any other desired manner.

FIG. 2b illustrates the state of the partially produced object 2 after the layer bearing the defect 12 has been removed. Process parameters of the apparatus 1 may be changed on the basis of the building-quality parameter which was previously output and, in particular on the basis of the captured defect 12, determined. For example, path planning by which the material deposition and the movement of the processing head 3 are defined may be changed. In this case, in particular cooling times or waiting times between the material deposition operations at different locations or in different layers may be increased in order to ensure sufficient dissipation of heat. If, for example, the defect 12 has been caused in that a seam in the region of the object 2 was formed flatter than how it would have to be formed in a target state, the capturing apparatus 5 can ascertain that the processing temperature of the building material 4 in this region was too high, so that the path planning may be adapted accordingly in order to increase the cooling time or waiting time.

The previously removed layer can subsequently be deposited again on the basis of the changed process parameter or the changed set of process parameters. In this way, the object, as illustrated in FIG. 2c, can be produced completely without the defect 12 in the previously removed layer occurring again during the renewed deposition of the layer. As described previously, if correction of the defect 12 is not possible, the building process can also be terminated.

As a further alternative to the termination of the building process or to the removal of the layer having the defect 12, FIGS. 3a-3c illustrate how compensation of the defect 12 can be carried out in layers situated thereabove. FIG. 3a shows, merely by way of example, a state in which a defect 12 has been captured, for example again via the capturing devices 7, 10. A building-quality parameter that characterizes the defect 12 can correspondingly be determined.

If in this case, for example, a gap which can be corrected in the next layer is involved, this action may, as illustrated in FIG. 3b, be performed. For example, the defect 12 can be closed off by filling the gap and the further layer can be deposited thereabove. Furthermore, on the basis of the determined building-quality parameter, it is possible for the process parameters that describe the carrying-out of the production process by the apparatus 1 to be adapted. For example, a wire advancing rate can be adapted. FIG. 3c shows the object 2 produced, wherein the defect 12 illustrated in FIG. 3a was compensated by adapting the further production process, as shown in FIG. 3b.

The advantages, details and features shown in the individual exemplary embodiments are, in any desired manner, combinable with one another, interchangeable with one another and transferable to one another. The apparatus 1 is configured, in particular, to carry out the method described herein.

List of reference signs

| | |
|---|---|
| 1 | Apparatus |
| 2 | Object |
| 3 | Processing head |
| 4 | Building material |
| 5 | Capturing apparatus |
| 6-10 | Capturing device |
| 11, 11′ | Surface |
| 12 | Defect |
| 13 | Milling device |

1.-10. (canceled)

11. A method for additive manufacture of three-dimensional objects by way of arc-wire deposition welding comprising layer-by-layer melting and solidification of a building material which is wire-shaped in its initial state,
wherein during the production process, at least two different surfaces of at least one partially produced three-dimensional object are captured by way of at least two different capturing devices, and
wherein at least one building-quality parameter, which describes a building quality of the object, is determined.

12. The method according to claim 11, wherein the building-quality parameter is determined for at least two surfaces of the object by way of capturing devices which are oriented differently with respect to one another.

13. The method according to claim 11, wherein the building-quality parameter is determined for all the surfaces of the object by way of capturing devices which are oriented differently with respect to one another.

14. The method according to claim 11, wherein the building-quality parameter is determined for at least two surfaces of the object by way of capturing devices which are oriented at least 90° with respect to one another.

15. The method according to claim 11, wherein at least one defect is captured in at least one surface of the object, and the building-quality parameter is determined on the basis of the captured defect.

16. The method according to claim 11, wherein the building-quality parameter is determined on the basis of at least one defect captured by way of a capturing algorithm, artificial intelligence, computer vision, and/or pattern recognition.

17. The method according to claim 16, wherein the at least one defect is captured on the basis of a deviation of a captured surface from a target state.

18. The method according to claim 11, wherein at least one process parameter is adapted according to the building-quality parameter, the at least one process parameter comprising a gas flow rate and/or path planning and/or a wire advancing rate and/or an advancing rate of a processing head and/or a waiting time between two deposited layers and/or a cooling time and/or a process temperature and/or a component property.

19. The method according to claim 11, wherein termination of the building process or correction of a determined defect is carried out according to the building-quality parameter.

20. The method according to claim 11, wherein, for correcting a determined defect, compensation of the defect is carried out in at least one subsequent layer, in particular with a change to at least one process parameter, and/or at least one layer having the defect is removed and a new layer, in particular with a change to at least one process parameter, is deposited.

21. The method according to claim 11, wherein the at least two different surfaces of the object are captured by way of a CCD and/or a CMOS and/or a thermal image, based on color and/or temperature and/or on depth information.

22. An apparatus for additive manufacture of three-dimensional objects by way of arc-wire deposition welding comprising layer-by-layer melting and solidification of a building material which is wire-shaped in its initial state, the apparatus comprising:
a capturing apparatus with at least two differently oriented capturing devices which are configured to capture at least two different surfaces of at least one partially produced three-dimensional object during the production process, and
a processor configured to determine at least one building-quality parameter, which describes a building quality of the object.
